(19) United States
(12) Patent Application Publication
(10) Pub. No.: US 2008/0232763 A1
(43) Pub. Date: Sep. 25, 2008

(54) SYSTEM AND METHOD FOR ADJUSTMENT OF VIDEO PLAYBACK RESOLUTION

(76) Inventor: Colin Brady, Sunnyvale, CA (US)

Correspondence Address: YAHOO! INC.;C/O DREIER LLP, 499 PARK AVENUE, NEW YORK, NY, 10022, US

(21) Appl. No.: 11/686,436

(22) Filed: Mar. 15, 2007

(51) Int. Cl. H04N 5/91; G06F 15/00; H04N 11/02; H04N 17/00

(52) U.S. Cl. 386/46; 375/240.01; 348/181; 375/E07.076; 348/E17.001

(57) ABSTRACT

Embodiments of the invention are directed towards methods and systems for playback of a content item by a media player. The method according to one embodiment comprises loading a content item into the media player, checking user preferences to retrieve a user value function and determining if available bandwidth exceeds a threshold. If the available bandwidth exceeds the threshold, the method initiates playback of the content item by the media player. If the available bandwidth is below the threshold, the method initiates playback of the content item by the media player on the basis of the available bandwidth and the user value function. If the media player is unable to retrieve the user value function, the method presents a calibration interface at the media player, the calibration interface operative to receive a user value function from a user and optimize playback of the content item.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to media players and rendering of content items through use of the same. More specifically, the present invention relates to the methods and software for allowing users to balance between load time and quality in rendering or otherwise playing back content items delivered electronically to a media player.

### BACKGROUND OF THE INVENTION

The amount of online video content has exploded recently with the development of various web sites that allow users to share content items online for playback by other users. There are many formats for the playback of professional or amateur videos, such as Yahoo Video Player, Real Player, QuickTime player, Windows Media Player, Flash players, etc. These players have the option of playing online streaming content within an Internet browser. Many players may also run as stand-alone programs that play content stored locally or from a remote server.

One problem associated with the playback of content items over a computer network is that bandwidth available over a given network connection may be limited. When attempting to playback large content items over a limited bandwidth network connection, playback may be choppy due to latency in receiving data packets that the player requires for playback of the content item. Alternatively, or in conjunction with the foregoing problem, there may be unacceptable delays when receiving large content items over a limed bandwidth connection. User's often have limited or no choice in their preference between the quality of content and delay in playback of a desired content item.

Different media players implement various methodologies for the playback of content items that a media player receives through a network. Some media players are operative to playback a content item as the player receives the content item, playback of a content stream without buffering the stream prior to playback. Other players, however, buffer content at full quality before initiating playback the content item. Still other players stream content items, on the basis on the bandwidth available to the media player, which does not necessarily include playback of a given content item at full quality.

Various media players heretofore know to those of skill in the art, however, fail to account for the dual preference of a user to balance immediacy and quality with respect to deliver of a content item, e.g., the desire of a user for playback of a content item on demand often conflicts with his or her wish to a high-quality content item. Thus, embodiments of the present invention provide systems and methods that allow for the optimization of the delivery and playback of a content item in a manner that is suitable for a given user or class or users.

### SUMMARY OF THE INVENTION

The present invention provides systems, method and computer readable media comprising program code to facilitate users in choosing between desired latency and quality of video content delivered electronically over a network and to be played in a media player. A method according to one embodiment of the invention comprises loading a content item into the media player, checking user preferences to retrieve a user value function and determining if available bandwidth exceeds a threshold. According to embodiments of the invention, the user value function may be a collection of one or more preferences, or may be an extrapolation based on a collection of one or more preferences. If the available bandwidth exceeds the threshold, the method comprises initiating playback of the content item by the media player. If the available bandwidth is below the threshold, the method comprises initiating a playback of the content item by the media player on the basis of the available bandwidth and the user value function. If the media player is unable to retrieve the user value function, the method comprises presenting a calibration interface at the media player, the calibration interface operative to receive a user value function from a user and optimize playback of the content item.

Where the available bandwidth exceeds the threshold, the method comprises streaming the content item to the media player at a high quality. The step of checking user preferences comprises checking the user value function associated with a specific type content item loaded into the media player if the bandwidth is below the threshold. According to one embodiment, a user value function is associated with a duration of the content item loaded into the media player if the bandwidth is below the threshold, e.g., multiple user value functions may be set, a given user value function associated with a content items of a given duration or duration range. A video session may be buffered in accordance with the user value function.

The method player may present a calibration interface comprising one or more controls. According to on embodiment, presenting the calibration interface comprises presenting a quality latency interactive user-interface element operative to set a user value function indicating a balance between quality and latency. Presenting the calibration interface may also comprise presenting a start-delay indicator operative to display an amount of time until initiation of playback of the content at the currently selected user value function. Finally, presenting the calibration interface may comprise presenting a visual control operative to display the expected content item playback quality on the basis of the currently selected user value function.

The user value function for quality and latency may be stored for a selected content type. Storing the user value function may also comprise storing the user value function in association with a given class of content items. The method may display or otherwise present the calibration interface in response to a number of events. For example, the calibration interface may be presented if retrieving the user value function fails. Alternatively, or in conjunction with the foregoing, the calibration interface may be presented in response to user interaction with the media player. The media content may be played with sufficient buffering to achieve the quality and latency requirements according to the user value function. Playback of the content item may be initiated by the media player on the basis of the available bandwidth and the user value function comprising playback on the basis of one or more user preferences.

The media player may be executed in a number of modes of operative. According to one embodiment, the media player executes embedded in another application. The another application may be, for example, a web browser. Alternatively, or additionally, the media player may be executed as a stand-alone application.

### BRIEF DESCRIPTION OF THE DRAWINGS

The invention is illustrated in the figures of the accompanying drawings, which are meant to be exemplary and not limiting, in which like references are intended to refer to like or corresponding parts, and in which:

FIG. 1A is a block diagram illustrating a system for optimizing the playback of a content item by a media player application in a manner that is suitable for a given user or class or users according to one embodiment of the present invention;

FIG. 1B is a block diagram illustrating the components of a media player according to one embodiment of the present invention;

FIG. 2 is flow diagram illustrating the operation of a media player application to optimize playback of a content item in a manner that is suitable for a given user or class or users according to one embodiment of the present invention;

FIG. 3 is flow diagram illustrating the operation of a media player application to modify playback of a content item in a manner that is suitable for a given user or class or users according to one embodiment of the present invention;

FIG. 4 illustrates a screen diagram of a media player and calibration interface according to one embodiment of the present invention; and

FIGS. 5A and 5B illustrate two screen diagrams comparing video content being played in the media player at high quality with high latency and at low quality with low latency, respectively, in accordance with an embodiment of the invention.

### DETAILED DESCRIPTION OF THE EMBODIMENTS

In the following description of embodiments of the invention, reference is made to the accompanying drawings that form a part hereof and in which is shown by way of illustration a number of specific embodiments in which the invention may be practiced. It is to be understood that other embodiments may be utilized and structural changes may be made without departing from the scope of the present invention.

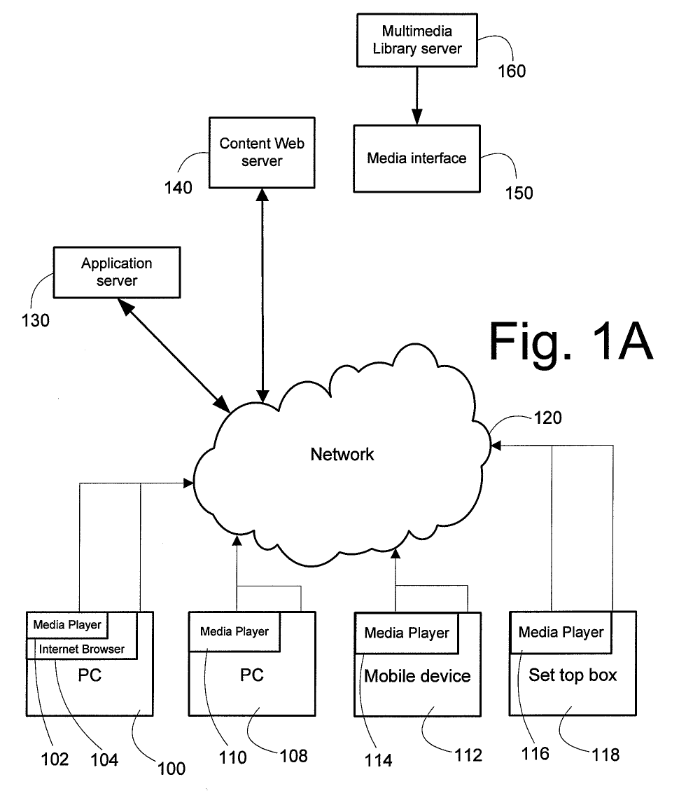

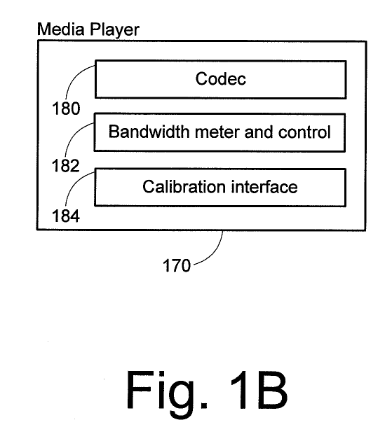

FIG. 1A presents a block diagram illustrating an environment in which various embodiments of the invention may be implemented. The system of FIG. 1A includes one or more client devices 100, 108, 112 and 118. Exemplary client devices include personal computers 100 and 108, mobile devices 112 (such as smartphones and PDAs), and a set-top boxes 118. A given client device 100, 108, 112 and 118 comprises a microprocessor, persistent storage and transient storage devices (not pictured), which are operative to maintain program code and data for execution by the microprocessor. Exemplary program code at the client device 100, 108, 112 and 118 includes a media player 102, 110, 114, 116, respectively, which may execute within an Internet browser 104 or as a stand-alone application. A client device may download a media player application from an application server 130 over the network 120.

A given client device, as well as a media player executing thereon, are in communication with a content provider through a network 120. The network 120 may comprise various combinations of wired and wireless local and wide area networks, e.g., the Internet, an intranet or combinations thereof. Through communication over the network 120, a media player 102, 110, 114, 116 is operative to receive one or more content items from a content web server 140. Similarly, a media player 102, 110, 114, 116 may communicate over the network to connect to a multimedia library server 160. A multimedia library server 160 may provide one or more content items to a media player 102, 110, 114, 116 through a multimedia interface 150.

There are many systems and platforms in which this invention may be distributed and used, which are generally well known to those of skill in the art. In one embodiment a given client device 100, 108, 112 and 118 may initially download the media player installation files from an application server 130 and install the media player application 102, 110, 114 and 116. The media player 102, 110, 114 and 116 may be installed as plug-in or to otherwise run within a browser 104, such as Internet Explorer or Firefox. In accordance with another embodiment, the media player 102, 110, 114 and 116 may be run outside the browser 104. Accordingly, it is possible for the media player 102, 110, 114 and 116 to work both as plug-in and as stand-alone program.

One embodiment of a media player in accordance with the present invention is illustrated in FIG. 1B. The media player 170 of FIG. 1B comprises a compressor/decompressor (“codec”) 180, a bandwidth meter control module 182 and a calibration interface 184. The media player 170 utilizes the codec 180 to decompress and render the content item that the media player 180 receives, which the media player 180 may receive from a local source or a remote source, e.g., over the network.

The bandwidth meter control module 182 comprises business logic that controls the playback of a given content item, which may include control of the codec 170. The bandwidth meter control module 182 may make a determination that if available bandwidth is sufficient to stream the content item at high quality or at a high enough quality for the user then the media player 170 initiates playback of the content item. Otherwise, the bandwidth meter control module 182 checks to determine if the user has set a user value function to indicate his or her preference of playback quality versus delivery time. Where the bandwidth meter control module 182 identifies a user value function, the media player 170 initiates a buffered video session at the quality indicated by the user value function.

Where insufficient bandwidth is available for high quality playback of a content item that the user selects with low latency, and the bandwidth meter control module 182 is unable to identify or retrieve a user value function (which is described herein in greater detail) the media player 170 may present the user with a calibration interface 184. According to one embodiment, the calibration interface 184 records a preference for a given user with regard to quality versus latency. The preference may be made for the target content type. The media player 170 stores the user preference (user value function) and initiates playback of the content item that the user selects with sufficient buffer to achieve the target quality and latency requirements or preferences of the user.

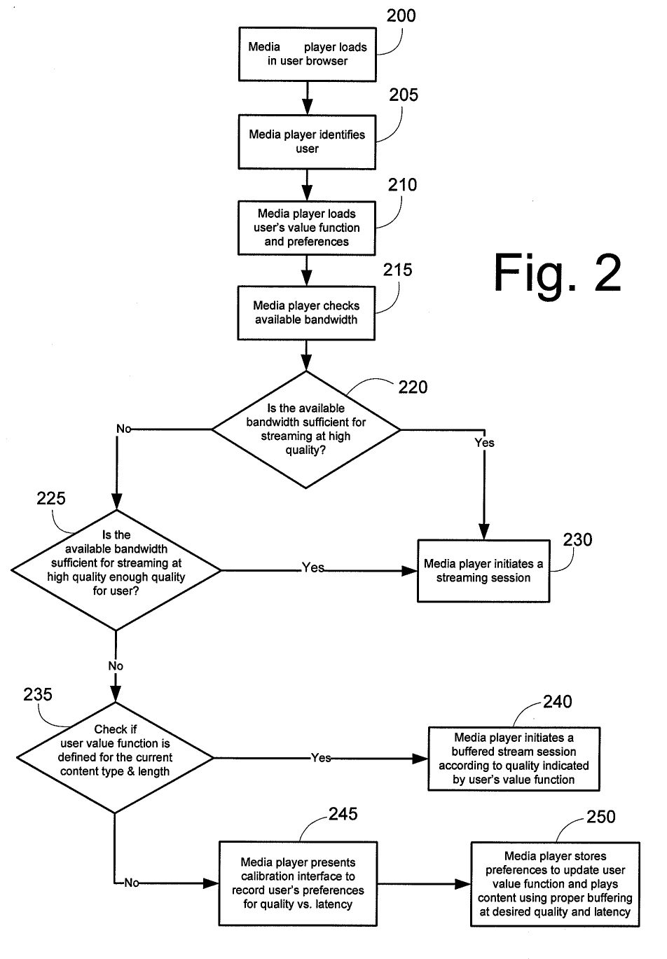

After the media player program in installed on an application device, a client user may use select one or more content items for playback that are located on a server that is remote to the client device. In one embodiment a user may select a content item for playback through interaction with a web browser. The content item be video, audio, images, as well as combinations thereof. FIG. 2 is flow diagram illustrating the operation of a media player application to optimize playback of a content item in a manner that is suitable for a given user or class or users according to one embodiment of the present invention. According to the embodiment of FIG. 2, the internet browser at a client device loads the media player in response to a selection of a content item, step 200. Alternatively, the media player may initialize and execute as a stand-alone application program for the playback of content items. In other embodiments, the media player may initialize and execute to allow the user to select one or more content items from a remote server for playback.

After the media player begins execution, the media player may attempt to identify the user of the client device or media player, step 205. Identification of a user that is utilizing the client device or media player may be used to retrieve or otherwise obtain settings, preferences, user value function and other information associated with a particular user, step 210. This process may consist of reading cookies or other similar files stored locally on the client device. The user's identity may be stored locally with one or more user preferences and other information. Alternatively, these data may be stored remotely and downloaded through the network.

The user value function is used to indicate the manner in which the media player is operative to playback a given content item continuously while client retrieves the content item from a remote source. The user value function may comprise one or more parameters that represent user preferences for the optimization of the playback of a content item as a function of quality against latency. In low bandwidth or other high latency network configurations, quality and latency may be in opposition to each other. Video content, as one exemplary type of content item, typically requires more bandwidth than audio, which may be a function of the quality at which the media player is to playback the video. To play at a high quality in a bandwidth constrained network environment, playback latency would usually increase as the media player would have to create a sufficient buffer for the video before playing begins. The user value function is captures a preference of a given user for quality versus wait time in the playback of a content item. The user value function may be an actual linear or non-linear function, or other instructions that use for example, quality and latency parameters among others, to determine an amount of buffering to be use when streaming media content to the media player.

After retrieving and loading the user value function (which may include loading user preferences), the media player may perform a test of the bandwidth available to the client device, step 215. The result of the bandwidth test is provided as input to a check to determine if the bandwidth is sufficient for the playback of a selected content item at a high quality, step 220, which may be a highest quality available for the content item. If the bandwidth is sufficient to stream the content item at full quality, the media player initiates a high quality playback session, step 230. If the media player cannot play at full quality, the media player may check preferences for the user to and confirm if media play may playback the content item at a highest available quality without sacrificing or otherwise incurring unacceptable latency, step 225. If the check at step 225 evaluates to true, the media player may initiate playback of the content item at a highest available quality without sacrificing or otherwise incurring unacceptable latency, step 230.

Where bandwidth constraints prevent the streaming at a sufficient quality, step 225, the media player perform a check to determine if a user value function is available, step 235. The user value function may be defined generically, or may be defined for certain media types, duration times, media categories, etc. Accordingly, the media player may check to determine if a user value function is defined or available for the specific content type, length, etc. According to one embodiment, the user value function is applicable to certain video types or files, or video clips of certain lengths, such as only video clips under 1 minute. For example, it is possible that user value function is configured such as to instruct the media player that a user prefers content items to be played at a low quality if they are less than a minute, but at a much higher quality (and disregard concerns regarding latency that buffering incurs) if the content item is longer than a minute (or other time based threshold).

If the user value function is defined or otherwise available for content items selected for streaming, the media player is operative to use the user value function to set buffering for the playback of the content item to include buffering that ensures the proper tradeoff between quality and latency, step 240. If the user value function is not defined or otherwise available, however, the media player according to one embodiment of the invention presents a calibration interface to visually record playback preferences for a given user, step 245. As is described in greater detail herein, the calibration interface is operative to display or otherwise provide controls that allow a user to visually and intuitively set their streaming or playback preferences. The calibration interface may also allow the media player to learn the preferences and then update or adjust the user value function accordingly. These preferences may be stored and applied when initiating a session to implement the proper buffering and playback quality, step 250.

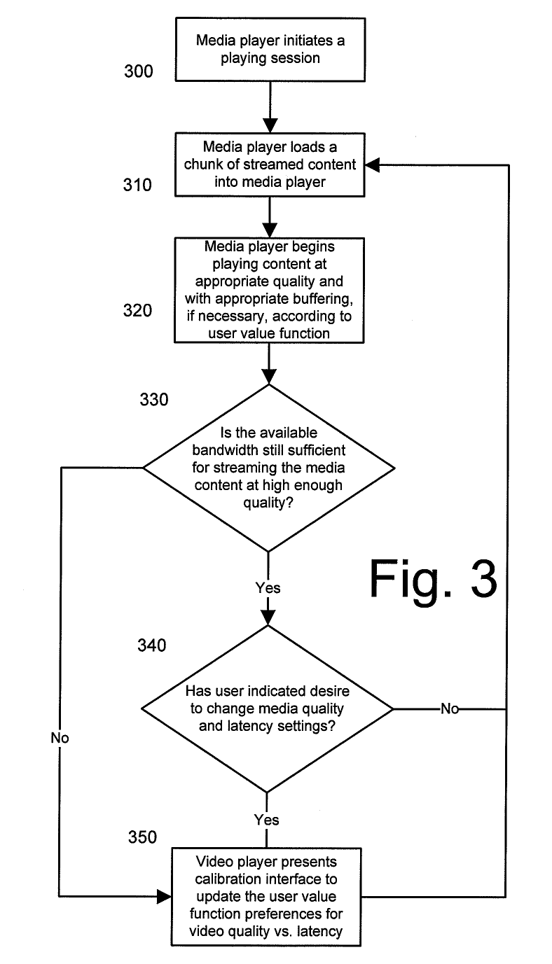

FIG. 3 presents a flow diagram illustrating one embodiment of a method for operating a media player application to modify playback of a content item in a manner that is suitable for a given user or class or users. According to the embodiment of FIG. 3, the media player is operating after the initiation of a playback session for a selected content item, step 300. The media player retrieves and loads one or more first packets of the content item that the stream comprises, step 310. The media player buffers the content item, step 320. Buffering may be performed in accordance with user preferences, with the user value function, available bandwidth, and various combinations thereof.

Before the media player loads a second one or more packets of the content item, the media player may reexamine the available bandwidth to determine if the available bandwidth is sufficient to meet playback quality and latency requirements as reflected by the current user value function, step 330. As those of skill in the art recognize, available bandwidth depends on many factors and may fluctuate as a function of time, sometimes drastically. If sufficient bandwidth is available for playback of the content item without comprising the current latency and quality requirements, the calibration interface may appear in response to some enumerated user interaction, such as a click on button, to indicate a desire to modify the existing user value function, steps 340 and 350. Alternatively, available bandwidth at the time the check is performed (step 330) may be insufficient to support playback quality and latency requirements. If the bandwidth can no longer sustain the latency and quality requirements, a calibration interface may be presented, step 350. If there is no desire or no need to change the user value function parameters, program flow returns to step 310 where the media player continues to load the content item, with the process looping until completion of the playback of the content item or manual termination of the process by the user.

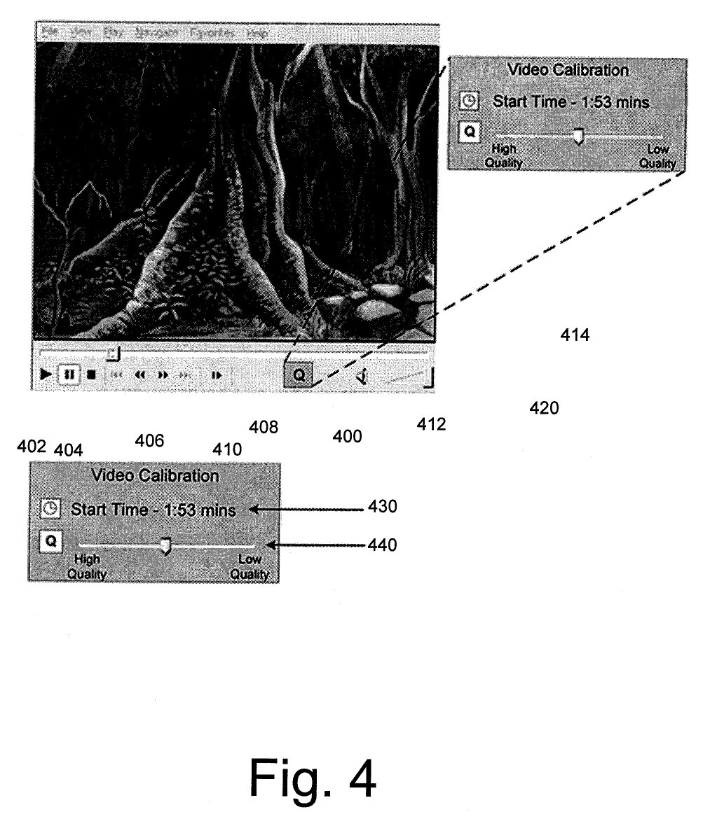

FIG. 4 illustrates a screen diagram of a media player and calibration interface according to one embodiment of the present invention. The media player 400 is shown with standard play 402, pause 404, stop 406, fast forward 408, rewind controls 410. The media player 400 comprises a “Q” button 412. Selection of the “Q” button 412 is operative to active a calibration interface 420 as indicated by the dashed lines 414. This calibration interface 420 comprises two elements, a Start-delay Indicator 430 and a Quality-Latency Selector 440. The Start-Delay Indicator 430 is an indication of an amount of time to delay prior to beginning playback of the video at a currently selected quality level. The Quality-Latency Selector 440 is an interactive element, such as a slider or other graphical element, which allows a user to choose between quality and latency in the playback of a content item or class or category of content item.

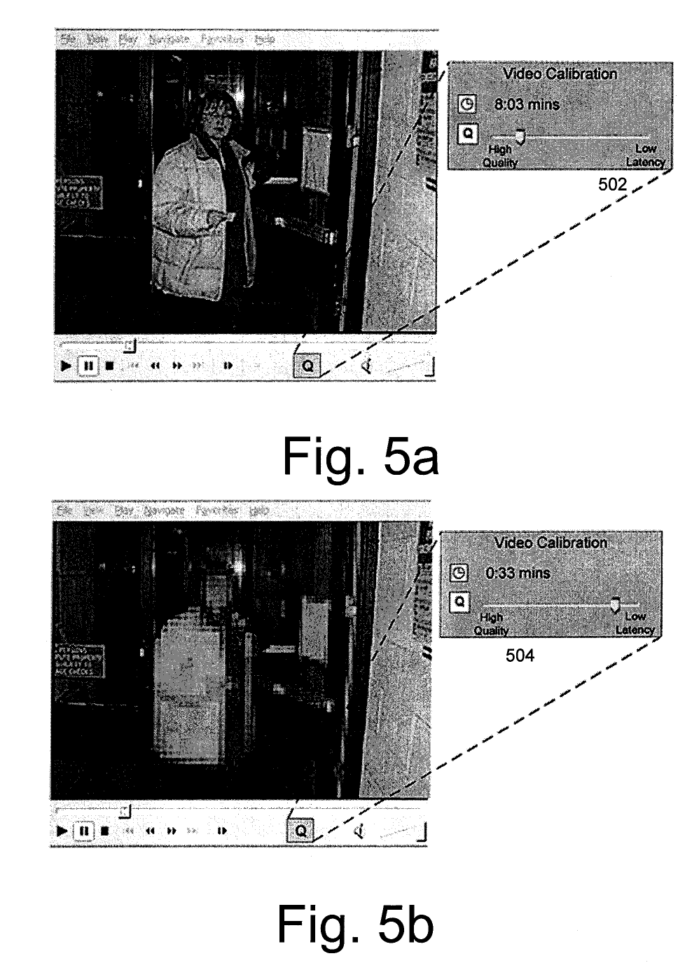

FIGS. 5A and 5B illustrate two screen diagrams comparing video content being played in the media player at high quality with high latency and at low quality with low latency, respectively, in accordance with an embodiment of the invention. FIGS. SA and 5B illustrate the effect of adjusting the Quality-Latency Selector 502 and 504. FIG 5A illustrates a video clip where the user configures the media player to playback the content item at a high quality. As a result, the latency or delay in the initiation of the playback of the content item is high. FIG. 5B illustrates the converse scenario where the user configures the media player to playback the content item with low latency, but as a result the video frame quality suffers.

The figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for playback of a content item by a media player, the method comprising:
loading a content item into the media player;
checking user preferences to retrieve a user value function;
determining if available bandwidth exceeds a threshold;
if the available bandwidth exceeds the threshold, initiating playback of the content item by the media player;
if the available bandwidth is below the threshold, initiating a playback of the content item by the media player on the basis of the available bandwidth and the user value function; and
if the media player is unable to retrieve the user value function, presenting a calibration interface at the media player, the calibration interface operative to receive a user value function from a user and optimize playback of the content item.

2. The method of claim 1, comprising streaming the content item to the media player at a high quality if the available bandwidth exceeds the threshold.

3. The method of claim 1, wherein checking user preferences comprises checking the user value function associated with a specific type content item loaded into the media player if the bandwidth is below the threshold.

4. The method of claim 1, wherein checking user preferences comprises checking the user value associated with a duration of the content item loaded into the media player if the bandwidth is below the threshold.

5. The method of claim 3, comprising initiating a buffering video session according to the user value function.

6. The method of claim 1, comprising presenting a calibration interface.

7. The method of claim 6 wherein presenting the calibration interface comprises:
presenting a quality latency interactive user-interface element operative to set a user value function indicating a balance between quality and latency;
presenting a start-delay indicator operative to display an amount of time until initiation of playback of the content at the currently selected user value function; and
presenting a visual control operative to display the expected content item playback quality on the basis of the currently selected user value function.

8. The method of claim 5 comprising storing the user value function for quality and latency for the selected content type.

9. The method of claim 5, wherein storing the user value function comprises storing the user value function in association with a given class of content items.

10. The method of claim 5, comprising presenting the calibration interface if retrieving the user value function fails.

11. The method of claim 5, comprising presenting the calibration interface in response to user interaction with the media player.

12. The method of claim 5, comprising playing the media content with sufficient buffering to achieve the quality and latency requirements according to the user value function.

13. The method of claim 1, comprising executing the media player embedded in another application.

14. The method of claim 13, wherein the another application is a web browser.

15. The method of claim 1, comprising executing the media player as a stand-alone application.

16. The method of claim 1, wherein initiating a playback of the content item by the media player on the basis of the available bandwidth and the user value function comprising playback on the basis of one or more user preferences.

17. Computer readable media for the storage of program code that when executed by a programmable processor initiates playback of a content item by a media player, the computer readable media comprising:
program code for loading a content item into the media player;
program code for checking user preferences to retrieve a user value function;
program code for determining if available bandwidth exceeds a threshold;
if the available bandwidth exceeds the threshold, program code for initiating playback of the content item by the media player;
if the available bandwidth is below the threshold, program code for initiating a playback of the content item by the media player on the basis of the available bandwidth and the user value function; and
if the media player is unable to retrieve the user value function, program code for presenting a calibration interface at the media player, the calibration interface operative to receive a user value function from a user and optimize playback of the content item.

18. The computer readable media of claim 17, comprising program code for streaming the content item to the media player at a high quality if the available bandwidth exceeds the threshold.

19. The computer readable media of claim 17, wherein program code for checking user preferences comprises program code for checking the user value associated with a specific type content item loaded into the media player if the bandwidth is below the threshold.

20. The computer readable media of claim 17, wherein program code for checking user preferences comprises program code for checking the user value associated with a duration of the content item loaded into the media player if the bandwidth is below the threshold.

21. The computer readable media of claim 19, comprising program code for initiating a buffering video session according to the user value function.

22. The computer readable media of claim 17, comprising program code for presenting a calibration interface.

23. The computer readable media of claim 22, wherein program code for presenting the calibration interface comprises:
program code for presenting a quality latency interactive user-interface element operative to set a user value function indicating a balance between quality and latency;
program code for presenting a start-delay indicator operative to display an amount of time until initiation of playback of the content at the currently selected user value function; and
program code for presenting a visual control operative to display the expected content item playback quality on the basis of the currently selected user value function.

24. The computer readable media of claim 22, comprising program code for storing the user value function for quality and latency for the selected content type.

25. The computer readable media of claim 22, wherein program code for storing the user value function comprises program code for storing the user value function is association with a given class of content items.

26. The computer readable media of claim 22, comprising program code for presenting the calibration interface if program code for retrieving the user value function fails.

27. The computer readable media of claim 22, comprising program code for presenting the calibration interface in response to user interaction with the media player.

28. The computer readable media of claim 22, comprising program code for playing the media content with sufficient buffering to achieve the quality and latency requirements according to the user value function.

29. The computer readable media of claim 17, comprising program code for executing the media player embedded in another application.

30. The computer readable media of claim 17, comprising program code for executing the media player as a stand-alone application.

31. The computer readable media of claim 17, wherein program code for initiating a playback of the content item by the media player on the basis of the available bandwidth and the user value function comprising playback on the basis of one or more user preferences.

32. A system for managing playback of a content item by a media player, the system comprising:
a calibration interface operative to present a quality latency interactive user-interface element operative to set a user value function indicating a balance between quality and latency, a start-delay indicator operative to display an amount of time until initiation of playback of the content at the currently selected user value function and a visual control operative to display the expected content item playback quality on the basis of the currently selected user value function.

33. The system of claim 32, comprising a compressor/decompressor (“codec”) operative to facilitate playback of the content item by the media player.

34. The system of claim 32, comprising a bandwidth meter and control component to stream the content item to the media player at a high quality if available bandwidth exceeds a threshold.

35. The system of claim 34, wherein the a bandwidth meter and control component checks the user value function associated with a specific type content item loaded into the media player to determine if the available bandwidth is below the threshold.

36. The system of claim 34, wherein the bandwidth meter and control component checks the user value function associated with a duration of the content item loaded into the media player if the available bandwidth is below the threshold.

37. The method of claim 32, wherein the calibration interface initiates a buffering video session according to the user value function.
